(19) United States
(12) Patent Application Publication
(10) Pub. No.: US 2023/0408060 A1
(43) Pub. Date: Dec. 21, 2023

(54) FOLDING LAMPSHADE

(71) Applicant: Dongguan Jufeng Lighting Products Co., Ltd., Dongguan (CN)

(72) Inventor: Deping Xue, Dongguan (CN)

(21) Appl. No.: 18/459,555

(22) Filed: Sep. 1, 2023

(51) Int. Cl. F21V 1/06

(52) U.S. Cl. CPC F21V 1/06

(57) ABSTRACT

The present disclosure provides a folding lampshade, and relates to the technical field of lampshades. The folding lampshade includes a lampshade body; an upper folding support and a lower folding support are respectively arranged at an upper end and a lower end of the lampshade body; the upper folding support includes a left upper support and a right upper support; upper fasteners are symmetrically mounted at joints of two ends of both the left upper support and the right upper support; supporting rods are symmetrically mounted on lower surfaces of the two ends of the left upper support; round lamp holder connectors are mounted at ends, close to each other, of the two groups of supporting rods; and the lower folding support includes a left lower support and the right lower support.

### TECHNICAL FIELD

The present disclosure relates to the technical field of lampshades, and particularly, to a folding lampshade.

### BACKGROUND

A lampshade is a device for covering a bulb and has functions of beautification and light adjustment. The lampshade can create different lighting effects and atmospheres by changing a direction, intensity, and scattering effect of light emitted by the bulb. As the living standard of people increases, forms of lampshades are increasingly diversified, one of which is a folding lampshade. However, the current folding lampshade has a relatively complicated overall structure in an actual use process, has a single shape, and is inconvenient to replace and mount, resulting in low flexibility, poor usage effect, and unsuitability for large-range popularization and use. The current folding lampshade needs to be improved.

### SUMMARY

The present disclosure aims to solve the technical problems mentioned in the background section described above.

The present disclosure adopts the following technical solutions: A folding lampshade includes a lampshade body; an upper folding support and a lower folding support are respectively arranged at an upper end and a lower end of the lampshade body; the upper folding support includes a left upper support and a right upper support; upper fasteners are symmetrically mounted at joints of two ends of both the left upper support and the right upper support; supporting rods are symmetrically mounted on lower surfaces of the two ends of the left upper support; round lamp holder connectors are mounted at ends, close to each other, of the two groups of supporting rods; the lower folding support includes a left lower support and a right lower support; and lower fasteners are symmetrically mounted at joints of two ends of both the left lower support and the right lower support.

Preferably, the joints of the two ends of both the left upper support and the right upper support and the joints of the two ends of both the left lower support and the right lower support are sleeved with sleeves. The sleeve structures stabilize unfolded states of the upper folding support and the lower folding support in an unfolding process.

Preferably, the lampshade body is of a cylindrical structure, and connection fasteners are mounted on inner walls of the upper and lower ends of the lampshade body. The cylindrical structure can facilitate the arrangement and mounting of the overall structure. The connection fasteners can cooperate with the support structures to further facilitate assembling.

Preferably, the left upper support and the right upper support, as well as the left lower support and the right lower support, are rotatably connected by the upper fasteners and the lower fasteners, respectively. A folding function between the upper folding support and the lower folding support can be achieved.

Preferably, each supporting rod is L-shaped, and mounting holes are symmetrically formed in the round lamp holder connectors in a penetrating manner. The L-shaped design will not interfere with the folding process of the upper folding support and the lower folding support, and the mounting holes facilitate combination and mounting with a lamp.

Preferably, an outer diameter of the left upper support and an outer diameter of the left lower support are the same as an inner diameter of the right upper support and an inner diameter of the right lower support, respectively. It can be ensured that the folding process is successful.

Preferably, each of the left upper support, the left lower support, the right upper support, and the right lower support is but not limited to semi-circular and U-shaped; and materials of the left upper support, the left lower support, the right upper support, and the right lower support are iron rings or iron wires. A shape between the upper folding support and the lower folding support is enriched, so as to better cooperate with lamps with different shapes.

Compared with the prior art, the present disclosure has the following advantages and beneficial effects.

In the present disclosure, through the arrangement of the structures of the upper folding support and the lower folding support, and the upper folding support and the lower folding support are connected using the upper fasteners and the lower fasteners (during connection, clamping is performed from bottom to top), so that the folding lampshade is more convenient to mount and can be mounted by direct separation; connection and mounting are achieved without using rivets and other structures, so that a perforating process is avoided, and the processing process is simplified; mounting and removal are quick and convenient; and the structural flexibility is fully improved.

### BRIEF DESCRIPTION OF THE DRAWINGS

FIG. 1 is a schematic diagram of an overall exploded structure of a folding lampshade according to the present disclosure.

FIG. 2 is a schematic structural diagram of an upper folding support of a folding lampshade according to the present disclosure.

FIG. 3 is a schematic structural diagram of a lower folding support of a folding lampshade according to the present disclosure.

FIG. 4 is a schematic structural diagram of joints of sleeves of a folding lampshade according to the present disclosure.

FIG. 5 is a schematic structural diagram of connection fasteners in a folding lampshade according to the present disclosure.

Illustrations in the drawings:
1: lampshade; 2: upper folding support; 3: lower folding support; 4: sleeve; 5: supporting rod; 6: round lamp holder connector; 7: connection fastener; 201: left upper support; 202: right upper support; 203: upper fastener; 301: left lower support; 302: right lower support; and 303: lower fastener.

### DETAILED DESCRIPTION OF THE EMBODIMENTS

In order to understand the above objectives, features and advantages of the present disclosure more clearly, the present disclosure will be further described below with reference to the accompanying drawings and embodiments. It should be noted that the embodiments of the present disclosure and features in the embodiments may be combined with each other without conflicts.

The following description illustrates many specific details in order to fully understand the present disclosure. However, the present disclosure can also be implemented in different other ways than those described here. Therefore, the present disclosure is not limited to the specific embodiments disclosed in the following specification.

Unless otherwise specified, reagents, methods, and equipment used in the present disclosure are conventional technical reagents, methods, and equipment in the art.

### First Embodiment

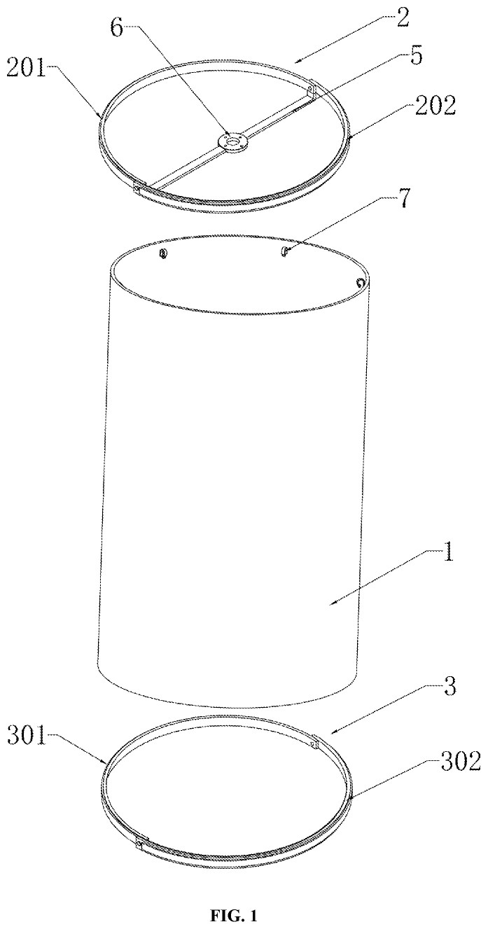

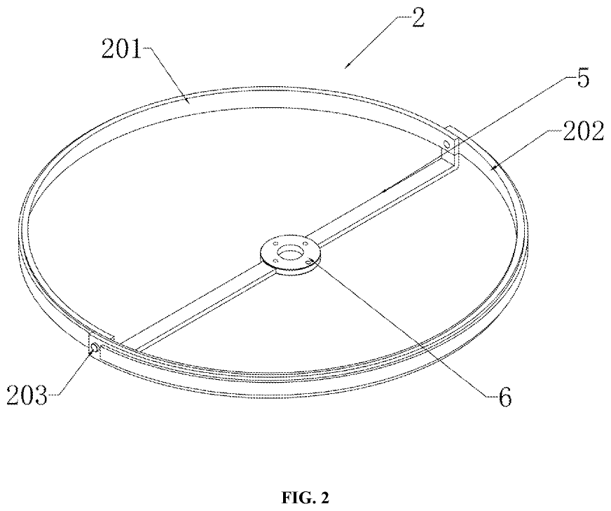

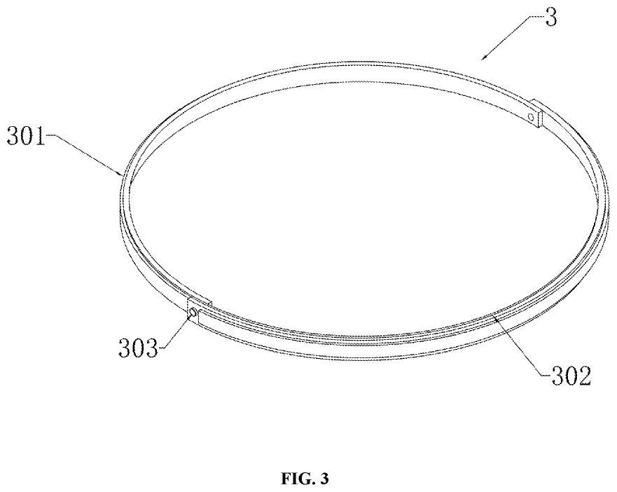

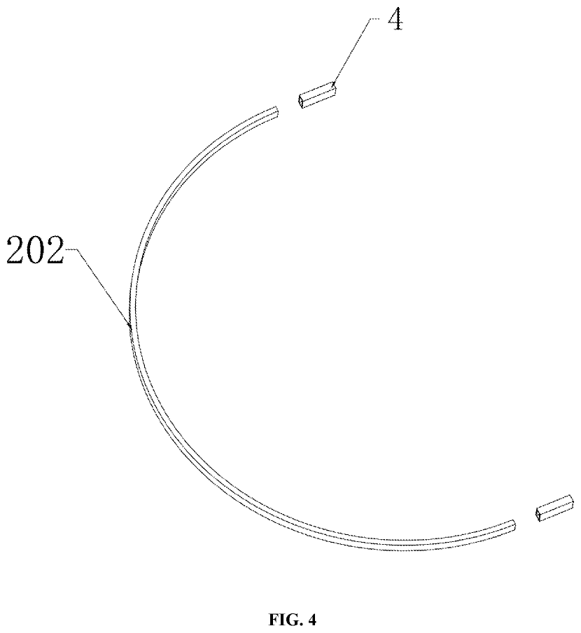

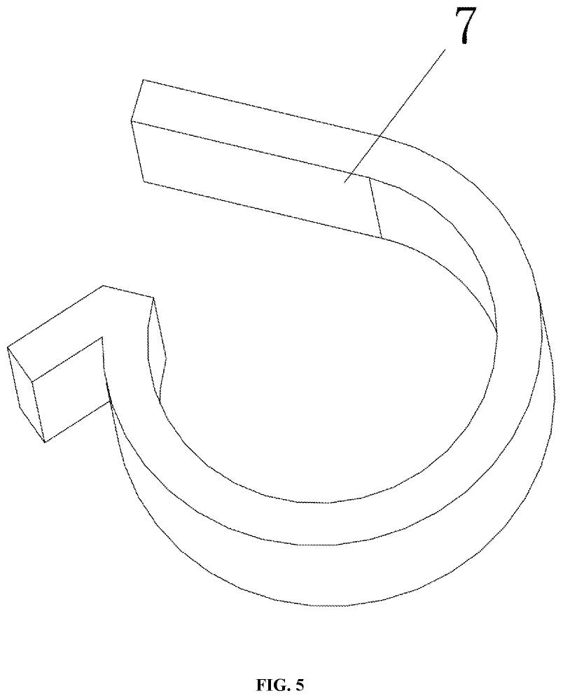

Referring to FIG. 1 to FIG. 5, the present disclosure provides a technical solution: A folding lampshade includes a lampshade body 1. An upper folding support 2 and a lower folding support 3 are respectively arranged at an upper end and a lower end of the lampshade body 1. The upper folding support 2 includes a left upper support 201 and a right upper support 202. Upper fasteners 203 are symmetrically mounted at joints of two ends of both the left upper support 201 and the right upper support 202. Supporting rods 5 are symmetrically mounted on lower surfaces of the two ends of the left upper support 201. Round lamp holder connectors 6 are mounted at ends, close to each other, of the two groups of supporting rods 5. The lower folding support 3 includes a left lower support 301 and a right lower support 302. Lower fasteners 303 are symmetrically mounted at joints of two ends of both the left lower support 301 and the right lower support 302. Through the arrangement of the structures of the upper folding support 2 and the lower folding support 3, and the upper folding support 2 and the lower folding support 3 are connected using the upper fasteners 203 and lower fasteners 303, so that the folding lampshade is more convenient to mount and can be mounted by direct separation; connection and mounting are achieved without using rivets and other structures, so that a perforating process is avoided, and the processing process is simplified; mounting and removal are quick and convenient; and the structural flexibility is fully improved.

Referring to FIG. 1 to FIG. 4, the joints of the two ends of both the left upper support 201 and the right upper support 202 and the joints of the two ends of both the left lower support 301 and the right lower support 302 are sleeved with sleeves 4. The sleeve structures stabilize unfolded states of the upper folding support 2 and the lower folding support 3 in an unfolding process, so as to ensure the stability of overall use of the lampshade body 1. The lampshade body 1 is of a cylindrical structure. The cylindrical structure can facilitate the arrangement and mounting of the entire structure. Connection fasteners 7 are mounted on inner walls of the upper and lower ends of the lampshade body 1. The connection fasteners 7 can cooperate with the support structures to further facilitate the assembling. The left upper support 201 and the right upper support 202, as well as the left lower support 301 and the right lower support 302, are rotatably connected by the upper fasteners 203 and the lower fasteners 303, respectively. A folding function between the upper folding support 2 and the lower folding support 3 can be achieved in a mounting manner of rotatable connection. Each supporting rod 5 is L-shaped, and mounting holes are symmetrically formed in the round lamp holder connectors 6 in a penetrating manner. The L-shaped design will not interfere with the folding process of the upper folding support 2 and the lower folding support 3, and the mounting holes facilitate combination and mounting with a lamp. An outer diameter of the left upper support 201 and an outer diameter of the left lower support 301 are the same as an inner diameter of the right upper support 202 and an inner diameter of the right lower support 302, respectively. Size adaptation can ensure that the folding process is successful. Each of the left upper support 201, the left lower support 301, the right upper support 202, and the right lower support 302 is but not limited to semi-circular and U-shaped; and materials of the left upper support 201, the left lower support 301, the right upper support 202, and the right lower support 302 are iron rings or iron wires. A shape between the upper folding support 2 and the lower folding support 3 is enriched, so as to better cooperate with lamps with different shapes.

The working principle is as follows: During assembling, the left upper support 201 and the right upper support 202 are first picked up. The two ends of the left upper support 201 and the two ends of the right upper support 202 (the left lower support 301 and the right lower support 302 are assembled in the same manner) are rotatably connected together through the upper fasteners 203 (which are clamped from top to bottom during connection). In this case, the assembling of the upper folding support 2 and the lower folding support 3 is completed. The upper folding support 2 and the lower folding support 3 are then respectively mounted at the upper and lower ends of the lampshade body 1 to complete the integral assembling of the structure. During folding, the upper folding support 2 and the lower folding support 3 are folded. During mounting, the round lamp holder connectors 6 are directly used to be connected to an external lamp.

Only preferred embodiments of the present disclosure are described above, and are not intended to limit the present disclosure in other forms. Anyone skilled in the art can change or modify the technical content disclosed above into equivalently changed equivalent embodiments which are applied to other fields. However, any simple alterations, equivalent changes and modifications made to the above embodiments according to the technical essence of the present disclosure without departing from the content of the technical solutions of the present disclosure still fall within the protection scope of the technical solutions of the present disclosure.

What is claimed is:

1. A folding lampshade, comprising a lampshade body (1), wherein an upper folding support (2) and a lower folding support (3) are respectively arranged at an upper end and a lower end of the lampshade body (1); the upper folding support (2) comprises a left upper support (201) and a right upper support (202); upper fasteners (203) are symmetrically mounted at joints of two ends of both the left upper support (201) and the right upper support (202); supporting rods (5) are symmetrically mounted on lower surfaces of the two ends of the left upper support (201); round lamp holder connectors (6) are mounted at ends, close to each other, of the two groups of supporting rods (5); the lower folding support (3) comprises a left lower support (301) and a right lower support (302); and lower fasteners (303) are symmetrically mounted at joints of two ends of both the left lower support (301) and the right lower support (302).

2. The folding lampshade according to claim 1, wherein the joints of the two ends of both the left upper support (201) and the right upper support (202) and the joints of the two ends of both the left lower support (301) and the right lower support (302) are sleeved with sleeves.

3. The folding lampshade according to claim 1, wherein the lampshade body (1) is of a cylindrical structure, and connection fasteners (7) are mounted on inner walls of the upper and lower ends of the lampshade body (1).

4. The folding lampshade according to claim 1, wherein the left upper support (201) and the right upper support (202), as well as the left lower support (301) and the right lower support (302), are rotatably connected by the upper fasteners (203) and the lower fasteners (303), respectively.

5. The folding lampshade according to claim 1, wherein each supporting rod (5) is L-shaped, and mounting holes are symmetrically formed in the round lamp holder connectors (6) in a penetrating manner.

6. The folding lampshade according to claim 1, wherein an outer diameter of the left upper support (201) and an outer diameter of the left lower support (301) are the same as an inner diameter of the right upper support (202) and an inner diameter of the right lower support (302), respectively.

7. The folding lampshade according to claim 1, wherein each of the left upper support (201), the left lower support (301), the right upper support (202), and the right lower support (302) is but not limited to semi-circular and U-shaped; and materials of the left upper support (201), the left lower support (301), the right upper support (202), and the right lower support (302) are iron rings or iron wires.
